(19) United States
(12) Patent Application Publication
(10) Pub. No.: US 2025/0125082 A1
(43) Pub. Date: Apr. 17, 2025

(54) LAMINATED COIL COMPONENT

(71) Applicant: TDK Corporation, Tokyo (JP)

(72) Inventors: Munehiro TAKAKU, Tokyo (JP); Kazuya Tobita, Tokyo (JP); Shinnosuke Suzuki, Tokyo (JP)

(73) Assignee: TDK Corporation, Tokyo (JP)

(21) Appl. No.: 18/889,765

(22) Filed: Sep. 19, 2024

(30) Foreign Application Priority Data
Oct. 16, 2023 (JP) 2023-178313

(51) Int. Cl. H01F 27/28; H01F 27/29; H01F 27/30

(52) U.S. Cl. CPC H01F 27/2828; H01F 27/292; H01F 27/306

(57) ABSTRACT

In the laminated coil component, in the third direction, the pair of the connecting portions are interposed between the pair of the end portions of the coil conductor and the pair of the terminal electrode. Since each of the connecting portions has the elongated portion extending from the overlapping portion overlapping the end portion of the coil conductor, the enlargement of the contact area with the terminal electrode is achieved, and the high connection reliability between the coil conductor and the terminal electrode is achieved.

### CROSS-REFERENCE TO RELATED APPLICATIONS

This application is based upon and claims the benefit of priority from Japanese Patent Application No. 2023-178313, filed on 16 Oct. 2023, the entire content of which is incorporated herein by reference.

### TECHNICAL FIELD

The present disclosure relates to a laminated coil component.

### BACKGROUND

Well known in the art is a laminated coil component, for example, described in Japanese Unexamined Patent Application Publication No. 2015-141945 (Patent Document 1). The laminated coil component described in Patent Document 1 includes an element body having a mounting surface and a main surface facing each other in a lamination direction, a coil conductor provided in the element body, and a pair of terminal electrodes provided on the mounting surface of the element body. The coil conductor includes wiring portions located on the main surface side, wiring portions located on the mounting surface side, and pillar portions extending in the lamination direction and connecting the wiring portions on the main surface side and the mounting surface side, and further includes a pair of end portions extending toward the mounting surface along the lamination direction.

### SUMMARY

In the above laminated coil component, since the end portion of the coil conductor are directly connected to the terminal electrode, the connection between the end portion of the coil conductor and the terminal electrode may become unstable, when a stress is applied to a section where the end portion of the coil conductor and the terminal electrode are connected, for example, an external force is applied to the terminal electrode. As a result, the characteristics of the laminated coil component may be degraded, or the laminated coil component may fail to function.

According to one aspect of the present disclosure, a laminated coil component in which connectivity between a coil conductor and a terminal electrode is enhanced is provided.

A laminated coil component according to one aspect of the present disclosure includes an element body configured with a plurality of laminated insulating layers and having a mounting surface intersecting with respect to a lamination direction, a coil conductor provided in the element body and having a pair of end portions extending toward the mounting surface along the lamination direction, a pair of terminal electrodes provided on the mounting surface of the element body, electrically connected to the pair of end portions of the coil conductor, respectively, and facing each other in a first direction on the mounting surface, and a pair of connecting portions interposed between the pair of the end portions of the coil conductor and the pair of the terminal electrodes, respectively. The coil conductor includes first wiring portions extending in parallel to the mounting surface, second wiring portions extending in parallel to the mounting surface at a side farther from the mounting surface than the first wiring portions, and pillar portions extending along the lamination direction and connecting the first wiring portion and the second wiring portion. The first wiring portion includes an inclined portion extending in a direction inclined with respect to the first direction and adjacent to the connecting portion in a second direction orthogonal to the lamination direction and the first direction when viewed from the lamination direction. The connecting portion has an overlapping portion overlapping the end portion of the coil conductor and an elongated portion extending inwardly from the overlapping portion along the first direction when viewed in the lamination direction, and wherein a length with respect to the second direction at a proximal end on the overlapping portion side of the elongated portion is longer than that at a distal end, and at least a portion of a contour of the elongated portion on the first wiring portion side is inclined in the same direction as the inclined portion of the first wiring portion when viewed from the lamination direction.

In the above laminated coil component, the pair of connecting portions are interposed between the pair of end portions of the coil conductor and the pair of terminal electrodes, respectively, in the lamination direction. Since the connecting portion has the elongated portion extending from the overlapping portion overlapping with the end portion of the coil conductor, and the end portion of the coil conductor is directly connected to the terminal electrode, a contact area with the terminal electrode is increased. Since at least a portion of the contour of the elongated portion of the connecting portion on the first wiring portion side is inclined in the same direction as the inclined portion of the first wiring portion of the coil conductor, the connectivity between the coil conductor and the terminal electrode can be enhanced while ensuring the spacing between the first wiring portion and the connecting portion.

In the laminated coil component according to another aspect, the whole of the contour of the elongated portion on the first wiring portion side is inclined in the same direction as the inclined portion of the first wiring portion when viewed from the lamination direction.

In the laminated coil component according to another aspect, the contour of the elongated portion on the first wiring portion side is inclined to be parallel to the inclined portion of the first wiring portion when viewed from the lamination direction.

In the laminated coil component according to another aspect, the shapes of the pair of the connecting portions have a symmetric relationship.

In the laminated coil component according to another aspect, the shapes of the pair of the connecting portions have an asymmetric relationship.

In the laminated coil component according to another aspect, an area of the end portion of the coil conductor is larger than an area of the pillar portion when viewed from the lamination direction.

### BRIEF DESCRIPTION OF THE DRAWINGS

FIG. 1 is a perspective view of a laminated coil component according to one embodiment.

FIG. 2 is an exploded perspective view showing a configuration of each layer of the laminated coil component shown in FIG. 1.

FIG. 3 is a side view of the laminated coil component shown in FIG. 1.

FIG. 4 is an end view of the laminated coil component shown in FIG. 1.

FIG. 5 is a view of the coil conductor and the pair of the connecting portion when viewed from a lamination direction.

FIG. 6 is a view showing a coil conductor and a pair of connecting portions according to an aspect different from FIG. 5.

FIG. 7 is a view showing a connecting portion according an aspect different from FIG. 5.

### DETAILED DESCRIPTION

Hereinafter, embodiments of the present disclosure will be described in detail with reference to the accompanying drawings. In the description, the same reference numerals are used for the same elements or elements having the same functions, and redundant description will be omitted.

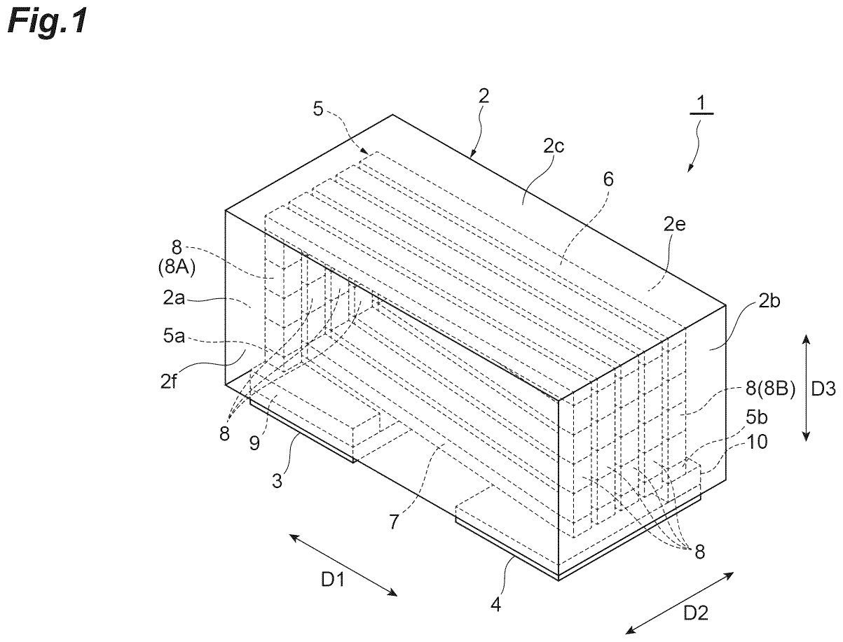

A laminated coil component according to the present embodiment will be described with reference to FIG. 1. FIG. 1 is a perspective view of a laminated coil component according to one embodiment. As shown in FIG. 1, the laminated coil component 1 is configured with an element body 2, a pair of terminal electrodes 3 and 4, and a coil conductor 5.

The element body 2 has a cuboid shape. The cuboid shape includes a cuboid shape in which the corner portions and the ridge portions are chamfered, and a cuboid shape in which the corner portions and the ridge portions are rounded. The element body 2 has, as the outer surface, a pair of end surfaces 2a and 2b, a pair of main surfaces 2c and 2d, and a pair of side surface 2e and 2f. The end surfaces 2a and 2b are opposing each other. The main surfaces 2c and 2d are opposing each other. The side surfaces 2e and 2f are opposing each other. Hereinafter, the opposing direction of the end surfaces 2a and 2b is a first direction D1, the opposing direction of the side surfaces 2e and 2f is a second direction D2, and the opposing direction of the main surfaces 2c and 2d is a third direction D3. The first direction D1, the third direction D3, and the second direction D2 are substantially orthogonal to each other.

The end surfaces 2a and 2b extend along the third direction D3 to join the main surfaces 2c and 2d. The end surfaces 2a and 2b also extend along the second direction D2 to join the side surfaces 2e and 2f. The main surfaces 2c and 2d, extend along the first direction D1 to join the end surfaces 2a and 2b. The main surfaces 2c and 2d also extend along the second direction D2 to join the side surfaces 2e and 2f. The side surfaces 2e and 2f extend along the first direction D1 to join the end surfaces 2a and 2b . The side surfaces 2e and 2f also extend along the third direction D3 to join the main surfaces 2c and 2d.

The main surface 2d is a mounting surface. For example, when the laminated coil component 1 is mounted on another electronic device (e.g., a circuit substance or a laminated electronic component) that is not shown, the mounting surface is a surface that faces another electronic device. The end surfaces 2a and 2b are continuous from the mounting surface (i.e., the main surface 2d).

The length of the element body 2 in the first direction D1 is longer than that in the second direction D2 and that in the third direction D3. The length of the element body 2 in the third direction D3 is shorter than that in the second direction D2. That is, in the present embodiment, each of the end surfaces 2a and 2b, the main surfaces 2c and 2d, the side surfaces 2e and 2f has a rectangular shape. The length of the element body 2 in the third direction D3 may be equivalent to that in the second direction D2, or may be longer than that in the second direction D2.

It should be noted that “equivalent” in the present embodiment may be a value including minute difference or manufacturing error in a range set in advance in addition to “equivalent”. For example, if a plurality of values is included in the range of 5% of the average value of the plurality of values, the plurality of values is defined as equivalent.

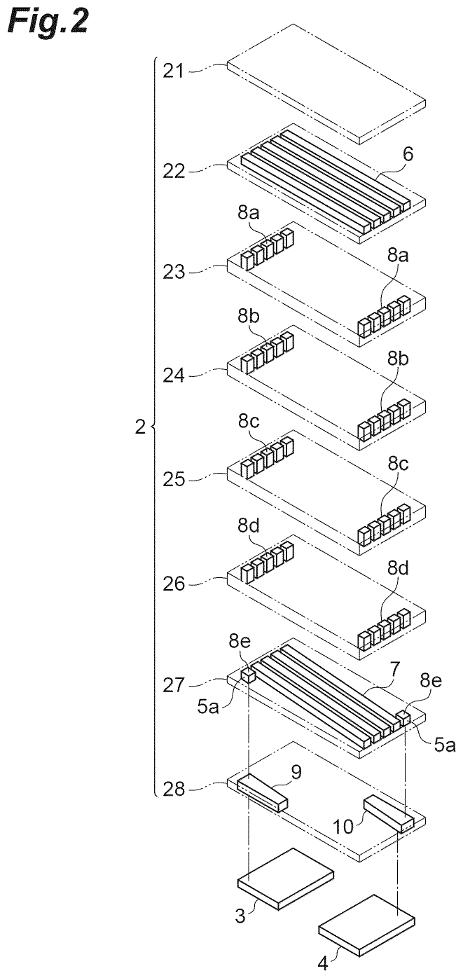

As shown in FIG. 2, the element body 2 has a configuration in which a plurality of element body layers is laminated in the third direction D3. In the present embodiment, the element body 2 is consist of eight layers, the element body layers 21 to 28. That is, the lamination direction of the element body 2 is same as the third direction D3. In the element body 2, actually, the plurality of the element body layer 21 to 28 may be integrated to such a degree that the interface of the interlayer cannot be visible or can be visible.

The element body layers 21 to 28 is mainly configured by a resin material. The resin material includes, for example, at least one selected from the group consisting of a liquid crystal polymer, a polyimide resin, a crystalline polystyrene, an epoxy-based resin, an acryl-based resin, a bismaleimide-based resin, and a fluorine-based resin. The resin material may or may not contain a filler. The filler is, for example, an inorganic filler. One of the inorganic filler is silica.

As shown in FIG. 2, the element body layer 21 constituting the main surface 2c, among the element body layers 21 to 28, is configured with only the resin material. In each of the element body layers 22 to 27, the wiring portions 6, 7, 8a to 8e constituting the coil conductor 5 are embedded. More specifically, the plurality of the second wiring portions 6 is embedded in the element body layer 22, the wiring portions 8a to 8d constituting a pillar portions 8 described below are embedded in the element body layers 23 to 26, and the plurality of the first wiring portions 7 and the wiring portions 8e constituting the pillar portions 8 is embedded in the element body layer 27. In the element body layer 28 constituting the main surface 2d, a pair of connecting portions 9 and 10 described below are embedded.

The element body layers 21 to 28 may be configured by a magnetic material. The magnetic material includes, for example, a Ni—Cu—Zn-based ferrite material, a Ni—Cu—Zn—Mg-based ferrite material, or a Ni—Cu-based ferrite material. The magnetic material may include an Fe alloy, for example. The element body layers 21 to 28 may include a non-magnetic material, and the non-magnetic material may be a glass-ceramic material or a dielectric material.

The pair of the terminal electrodes 3 and 4 are configured by a first terminal electrode 3 and a second terminal electrode 4. Each of the terminal electrodes 3 and 4 is provided in the element body 2. Each of the terminal electrodes 3 and 4 is arranged in the main surface 2d of the element body 2. The pair of the terminal electrodes 3 and 4 are provided in the element body 2 while being spaced from each other in the first direction D1. Specifically, the first terminal electrode 3 is provided on the end surface 2a side of the element body 2, and the second terminal electrode 4 is provided on the end surface 2b side of the element body 2.

Each of the terminal electrodes 3 and 4 has a rectangular shape when viewed from the third direction D3. The terminal electrodes 3 and 4 have the same dimensions. Each of the terminal electrodes 3 and 4 is provided so that each side of the rectangle is along the first direction D1 or the second direction D2. Each of the terminal electrodes 3 and 4 protrudes beyond the main surface 2d. That is, in the present embodiment, the surface of each the terminal electrodes 3 and 4, is not flush with the main surface 2d. The pair of the terminal electrodes 3 and 4 are configured by a conductive material (for example, Cu). The pair of the terminal electrodes 3 and 4, may be embedded in the element body 2. In this case, the pair of the terminal electrodes 3 and 4 may be substantially flush with the main surface 2d, or may protrude from the main surface 2d by a portion.

Each of the terminal electrodes 3 and 4 may be provided with a plating layer (not shown) containing Ni, Sn, Au, for example, by electrolytic plating or electroless plating. The plating layer may include, for example, a Ni-plating layer containing Ni and covering the terminal electrode 3 or 4, and an Au-plating layer containing Au and covering the Ni-plating layer.

The coil conductor 5 is provided in the element body 2. The coil conductor 5 has the second wiring portions 6, the first wiring portions 7, and the pillar portions 8. The coil conductor 5 is configured by electrically connecting the second wiring portions 6, the first wiring portions 7, and the pillar portions 8. The coil axis of the coil conductor 5 is provided along the second direction D2. The second wiring portion 6, the first wiring portions 7, and the pillar portions 8 are configured with a conductive material (e.g., Cu). The second wiring portion 6, the first wiring portion 7 and the pillar portion 8 are spaced from the end surfaces 2a and 2b, the main surfaces 2c and 2d and the side surfaces 2e and 2f.

Each of the second wiring portions 6 is located on the main surface 2c side of the element body 2. Each of the second wiring portion 6 extends along the first direction D1. Each of the second wiring portion 6 connects two of the pillar portions 8. The second wiring portion 6 is bridged by two of the pillar portions 8. One end of the second wiring portion 6 (end on the end surface 2a side) in the extending direction is connected to one end portion (end portion on the main surface 2c side) of the pillar portion 8. The other end of the second wiring portion 6 (end on the end surface 2b side) in the extending direction is connected to one end portion of the pillar portion 8.

Each of the first wiring portions 7 may is locate on the main surface 2d (mounting surface) side of the element body 2. Each of the first wiring portions 7 extends in the first direction D1. Each of the first wiring portions 7 connects two of the pillar portions 8. The first wiring portion 7 is bridged by two of the pillar portions 8. One end of the first wiring portion 7 (end on the end surface 2a side) in the extending direction is connected to the other end portion (end portion on the main surface 2d side) of the pillar portion 8. The other end of the first wiring portion 7 (end on the end surface 2b side) in the extending direction is connected to the other end portion of the pillar portion 8. The first wiring portions 7 have one less number than the second wiring portions 6. That is, when the number of the second wiring portions 6 is [n], the number of the first wiring portions 7 is [n−1]. In the present embodiment, the number of the second wiring portion 6 is [5] and the number of the first wiring portions 7 is [4].

Each of the first wiring portions 7 is entirely configured with an inclined portion 7a. In view of the third direction D3, the inclined portion 7a is inclined to the first direction D1 by a predetermined angle θ. The angle θ of the inclined portion 7a with regard to the first direction D1 is the same in all the first wiring portions 7. That is, the first wiring portions 7 have a parallel relationship with each other. By constituting the first wiring portion 7 entirely with the inclined portion 7a, the shape of the first wiring portion 7 is close to a linear shape without a step portion or a flex portion. Therefore, the electrical resistance when current flows through the first wiring portion 7 is suppressed to be low.

Each of the pillar portions 8 is located on the end surface 2a side or the end surface 2b side of the element body 2. Each of the pillar portions 8 extends along the third direction D3. The cross-sectional shape of the pillar portion 8 in a cross section orthogonal to the third direction D3 is substantially rectangular (specifically substantially square) in the present embodiment. The cross-sectional shape of the pillar portion 8 may be, for example, a circular shape, an elliptical shape, or a polygonal shape other than quadrangular. The pillar portion 8 connects the second wiring portion 6 and the first wiring portion 7. One end of the pillar portion 8 is connected to one end portion or the other end portion of the second wiring portion 6. The other end of the pillar portion 8 is connected to one end portion or the other end portion of the first wiring portion 7. Among the pillar portions 8, the pillar portion 8 closest to the side surface 2f has one end connected to one end portion of the second wiring portion 6 and the other end constituting an end portion 5a of the coil conductor 5. Among the pillar portions 8, the pillar portion 8 closest to the side surface 2e has one end of connected to one end portion of the second wiring portion 6 and the other end constituting an end portion 5b of the coil conductor 5. Both the pillar portion 8 close to the end surface 2a and the pillar portion 8 close to the end surface 2b may be designed such that the pillar portions are substantially pitched at an equal distance as shown in FIGS. 1 and 2, or may be designed such that the pillar portions are not pitched at an equal distance (at least some pitches of the pillar portions 8 are different).

In the element body 2, a pair of connecting portions 9 and 10 interposed between the pair of the end portions 5a and 5b and the pair of the terminal electrodes 3 and 4 of the coil conductor 5 are provided. The pair of the connecting portions 9 and 10 are configured by a first connecting portion 9 and a second connecting portion 10.

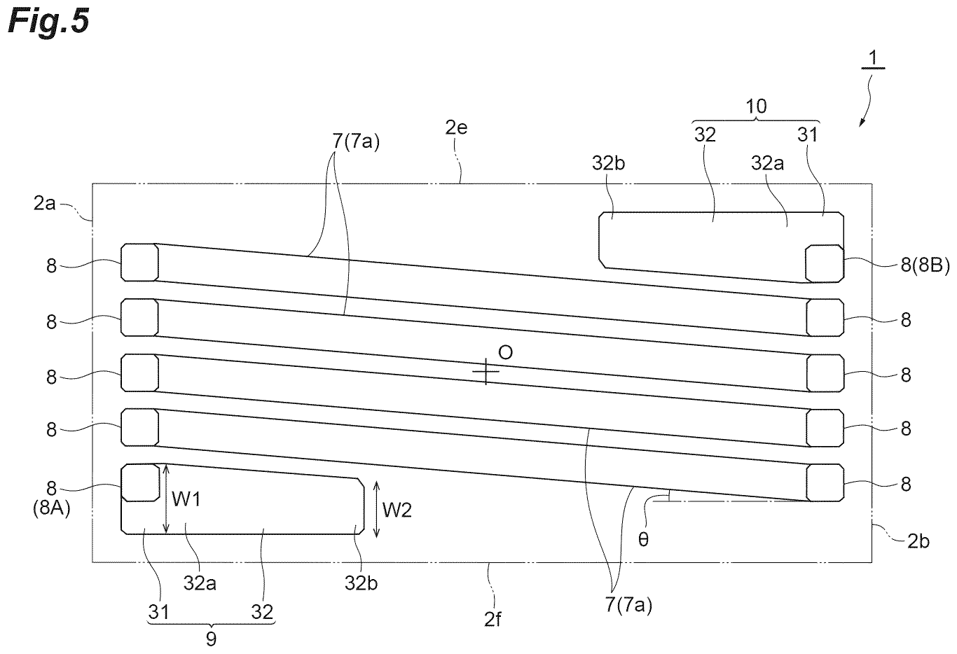

The first connecting portion 9 connects electrically between the first terminal electrode 3 and the end portion 5a of the coil conductor 5. The first connecting portion 9 is electrically connected to the other end portion of the pillar portion 8 of the coil conductor 5. The first connecting portion 9 is configured by a conductive material (for example, Cu). As shown in FIG. 5, the first connecting portion 9 includes an overlapping portion 31 and an elongated portion 32 when viewed from the third direction D3. The overlapping portion 31 is a portion that overlaps the end portion 5a of the coil conductor 5. In the present embodiment, the overlapping portion 31 has a substantially rectangular shape with each side along the first direction D1 or the second direction D2. The elongated portion 32 is a portion extending inwardly from the overlapping portion 31 along the first direction D1. The elongated portion 32 has a substantially trapezoidal shape tapering toward the inner side, and the width (i.e., the length in the second direction D2) of a distal end 32b corresponding to the upper base of the trapezoidal shape is narrower than the width of a proximal end 32a corresponding to the lower base of the trapezoidal shape. In the present embodiment, all of the contour of the elongated portion 32 on the first wiring portion 7 side are inclined in the same direction as the inclined portion 7a of the first wiring portion 7 (in FIG. 5, the direction of right down). In the present embodiment, all of the contour of the elongated portion 32 on the first wiring portion 7 side are inclined so as to be parallel to the inclined portion 7a of the first wiring portion 7. The contour of the elongated portion 32 on the side surface 2f side extends parallel to the first direction D1 from the proximal end 32a to the distal end 32b. The end of the first connecting portion 9 on the side surface 2f side may match the end of the first terminal electrode 3 on the side surface 2f side. The end of the first connecting portion 9 on the end surface 2a side may match the end of the first terminal electrode 3 on the end surface 2a side.

The second connecting portion 10 connects electrically between the first terminal electrode 3 and the end portion 5b of the coil conductor 5. The second connecting portion 10 is electrically connected to the other end portion of the pillar portion 8 of the coil conductor 5. The second connecting portion 10 is configured by a conductive material (for example, Cu). As shown in FIG. 5, the second connecting portion 10 has symmetry shape with the first connecting portion 9. Specifically, the shape of the second connecting portion 10 has a relationship of point symmetry with the shape of the first connecting portion 9 with regard to a center O of the main surface 2d. Thus, the shape of the first connecting portion 9 and the shape of the second connecting portion 10 have a symmetry relationship. Thus, the characteristic variation among the laminated coil components 1 can be suppressed.

The second connecting portion 10, similarly to the first connecting portion 9, has the overlapping portion 31 and the elongated portion 32 when viewed from the third direction D3. The overlapping portion 31 of the second connecting portion 10 is a portion that overlaps the end portion 5b of the coil conductor 5. The elongated portion 32 of the second connecting portion 10 is a portion extending inwardly from the overlapping portion 31 along the first direction D1. In the second connecting portion 10, similarly to the first connecting portion 9, all of the contour of the elongated portion 32 on the first wiring portion 7 side are inclined in the same direction as the inclined portion 7a of the first wiring portion 7 (in FIG. 5, the direction of right down). In the present embodiment, all of the contour of the elongated portion 32 on the first wiring portion 7 side are inclined so as to be parallel to the inclined portion 7a of the first wiring portion 7. The contour of the elongated portion 32 on the side surface 2e side extends parallel to the first direction D1 from the proximal end 32a to the distal end 32b. The end of the second connecting portion 10 on the side surface 2e side may match the end of the second terminal electrode 4 on the side surface 2e side. The end of the second connecting portion 10 on the end surface 2b side may match the end of the second terminal electrode 4 on the end surface 2b side.

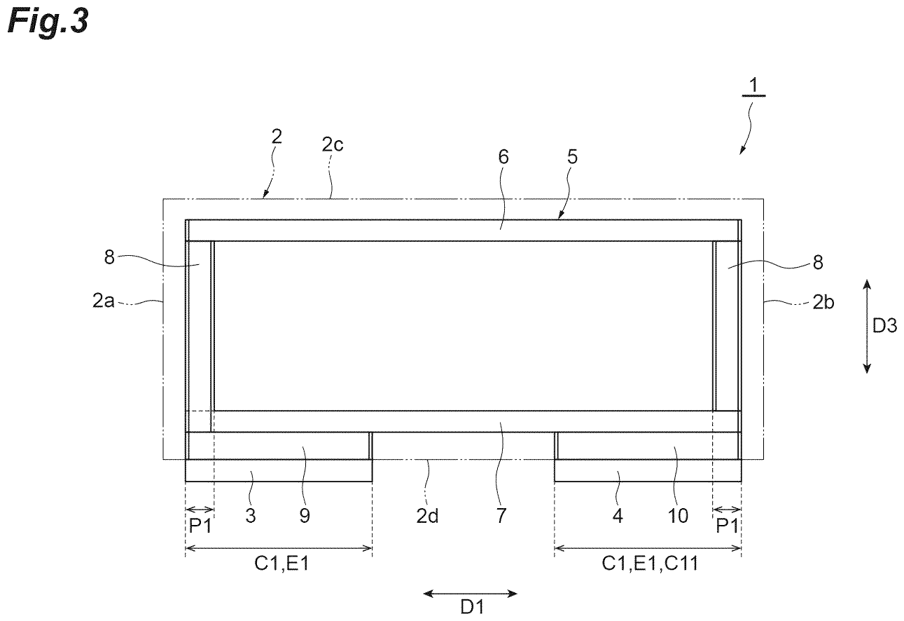

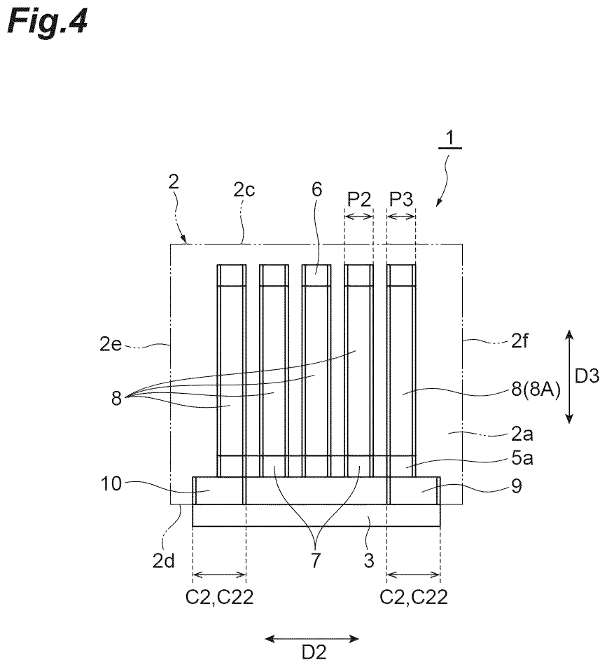

With regard to dimensions of the pair of the connecting portions 9 and 10, as shown in FIG. 3, the length C1 in the first direction D1 of the first connecting portion 9 is longer than the length P1 in the first direction D1 of the pillar portion 8 connected to the first connecting portion 9, and is not longer than the length E1 in the first direction D1 of the first terminal electrode 3 (P1<C1≤E1). In the present embodiment, the length C1 in the first direction D1 of the first connecting portion 9 is longer than the length P1 in the first direction D1 of the pillar portion 8 connected to the first connecting portion 9, and is the same as the length E1 in the first direction D1 of the first terminal electrode 3 (P1<C1=E1). The length C1 in the first direction D1 of the second connecting portion 10 is longer than the length P1 in the first direction D1 of the pillar portion 8 connected to the second connecting portion 10, and is not longer than the length E1 in the first direction D1 of the second terminal electrode 4 (P1<C1≤E1). In the present embodiment, the length C1 in the first direction D1 of the second connecting portion 10 is longer than the length P1 in the first direction D1 of the pillar portion 8 connected to the second connecting portion 10, and is the same as the length E1 in the first direction D1 of the second terminal electrode 4 (P1<C1=E1). As shown in FIG. 4, the length C2 in the second direction D2 of the first connecting portion 9 is not shorter than the length P2 in the second direction D2 of the pillar portion 8 connected to the first connecting portion 9 (C2≥P2). The length C2 in the second direction D2 of the second connecting portion 10 is not shorter than the length P2 in the second direction D2 of the pillar portion 8 connected to the second connecting portion 10 (C2≥P2). In the present embodiment, the length P3 in the second direction D2 of the pillar portion 8A constituting the pair of the end portions 5a and 5b of the coil conductor 5 is designed to be equal to the length P2 in the second direction D2 of the other of the pillar portion 8 (P3=P2). The length P3 in the second direction D2 of the pillar portion 8A may be designed to be longer than the length P2 in the second direction D2 of the other of the pillar portions 8 (P3>P2), and may be designed to be shorter (P3<P2). Accordingly, the coil characteristics (electrical characteristics, magnetic properties, etc.) may be adjusted appropriately. The length in the second direction D2 of the wiring portion 8e constituting the end portion 5a (or 5b) of the coil conductor 5 may be the same as the length in the second direction D2 of the other of the wiring portions 8a to 8d constituting the pillar portion 8A (or 8B), and may be longer than the length in the second direction D2 of the other of the wiring portions 8a to 8d. The length in the second direction D2 of the end portion 5a (or 5b) of the coil conductor 5 may be equal to the length C2 in the second direction D2 of the connecting portion 9 (or a connecting portion 10).

As described above, in the laminated coil component 1 according to the present embodiment, in the third direction D3, the pair of the connecting portions 9 and 10 are interposed between the pair of the end portions 5a and 5b of the coil conductor 5 and the pair of the terminal electrodes 3 and 4, respectively. The connecting portions 9 and 10 have, in addition to the overlapping portion 31 overlapping with the end portions 5a and 5b of the coil conductor 5, the elongated portion 32 extending from the overlapping portion 31 and the area of the connecting portions 9 and 10 are larger than the area of the end portions 5a and 5b of the coil conductor 5 when viewed from the third direction D3. Thus, the contact area with the terminal electrodes 3 and 4 are larger than if the connecting portions 9 and 10 are not interposed and the end portions 5a and 5b of the coil conductor 5 are in direct contact with the terminal electrodes 3 and 4. Thus, a high connection reliability between the coil conductor 5 and the terminal electrodes 3 and 4 is achieved.

In addition, in the laminated coil component 1 according to the present embodiment, the contour of the elongated portion 32 on the first wiring portion 7 side of the connecting portions 9 and 10 is inclined in the same direction as the inclined portion 7a of the first wiring portion 7 of the coil conductor 5. The area enlargement of the connecting portions 9 and 10 (i.e., the enlargement of the contact area with the terminal electrodes 3 and 4) can be achieved by bringing the elongated portion 32 of the connecting portions 9 and 10 close to the first wiring portion 7 while achieving the spacing between the first wiring portion 7 and the connecting portions 9 and 10.

As in the laminated coil component 1 according to the present embodiment, in the case that the contour of the elongated portion 32 on the first wiring portion 7 side of the connecting portions 9 and 10 is parallel to the inclined portion 7a of the first wiring portion 7, further area enlargement of the connecting portions 9 and 10 (i.e., enlargement of the contact area with the terminal electrodes 3 and 4) can be achieved because the elongated portion 32 of the connecting portions 9 and 10 can be brought closer to the first wiring portion 7 while achieving the spacing between the first wiring portion 7 and the connecting portions 9 and 10.

The present disclosure is not necessarily limited to the above embodiments, and various changes may be made without departing from the gist of the present disclosure.

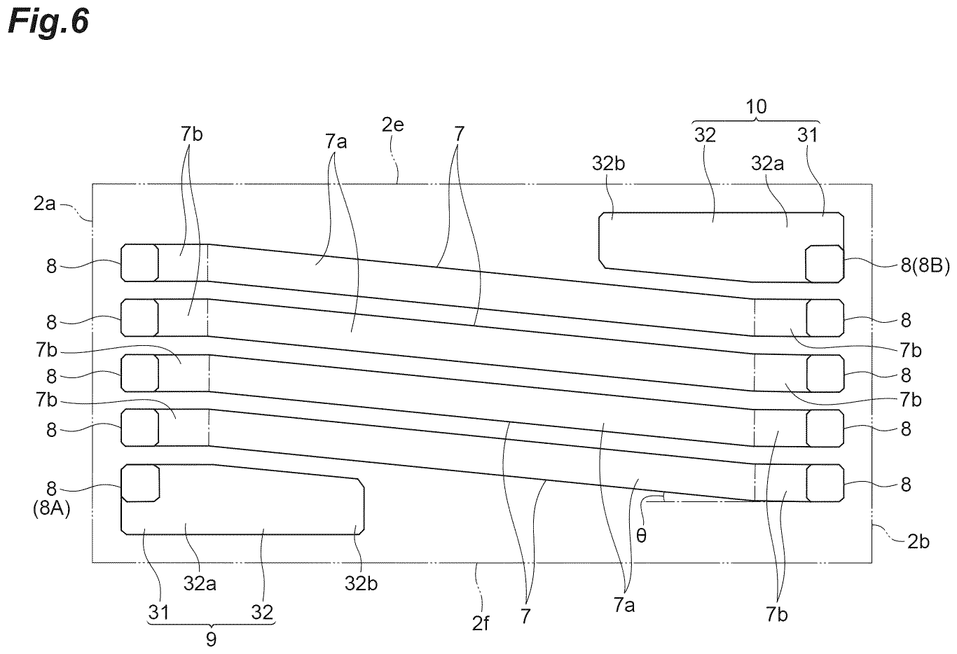

For example, the coil conductor 5 and the connecting portions 9 and 10 are not limited to the above shape and can be appropriately changed. In the embodiment shown in FIG. 6, each of the first wiring portions 7 in the coil conductor 5 further has a pair of uninclined portions 7b located in both end of the inclined portion 7a. Each of the uninclined portions 7b extends parallel to the first direction D1. One of the uninclined portions 7b includes a region overlapping with the pillar portion 8 corresponding when viewed from the third direction D3 and is positioned closer to the end surface 2a. The other of the uninclined portions 7b includes a region overlapping the pillar portion 8 corresponding when viewed from the third direction D3, and is positioned closer to the end surface 2b. The inclined portion 7a connects the pair of the uninclined portions 7b and is inclined to the first direction D1 by a predetermined angle θ when viewed from the third direction D3. The inclination angle θ of the inclined portion 7a with regard to the first direction D1 is the same in all the first wiring portions 7. That is, the first wiring portions 7 have a relationship of parallel to each other in the inclined portion 7a. Even in the embodiment shown in FIG. 6, the area enlargement of the connecting portions 9 and 10 (that is, the enlargement of the contact area with the terminal electrodes 3 and 4) can be achieved by bringing the elongated portion 32 of the connecting portions 9 and 10 close to the first wiring portions 7 while achieving the spacing between the first wiring portions 7 and the connecting portions 9 and 10. In the embodiment shown in FIG. 6, in particular, the region of the elongated portion 32 adjacent to the uninclined portion 7b in the second direction D2 can be brought close to the uninclined portion 7b, thereby achieving area enlargement of the connecting portions 9 and 10.

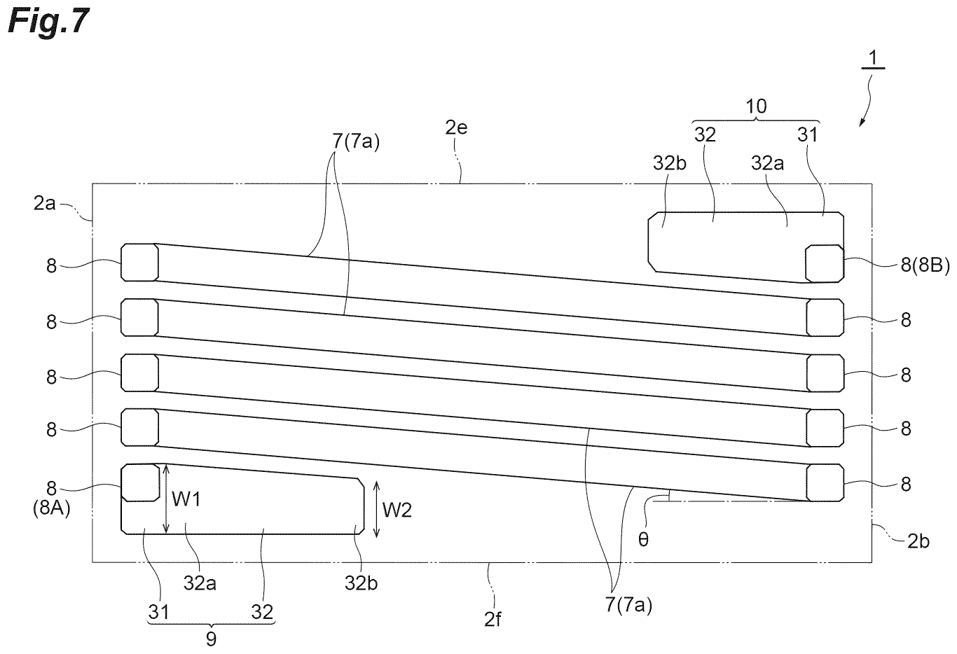

Further, the pair of the connecting portions 9 and 10 are not limited to aspects having a symmetry relationship, and may be aspects having an asymmetric relationship. For example, as shown in FIG. 7, the length in the first direction D1 may be different between the first connecting portion 9 and the second connecting portion 10, and the length of the second connecting portion 10 may be shorter than the length of the first connecting portion 9. By making the pair of the connecting portions 9 and 10 asymmetric, the polarity of the coil conductor 5 can be discriminated from the shape of the connecting portions 9 and 10, for example, in quality inspection of the element (traceability).

Further, each of the connecting portions 9 and 10 is not limited to a single-layer structure, but may be a multi-layer structure. That is, each of the connecting portions 9 and 10 may be configured with a plurality of layers that overlap in the third direction D3. In this case, the layers constituting the connecting portions 9 and 10 may have the same shape or different shapes when viewed from the third direction D3. When the layers constituting the connecting portions 9 and 10 have different shapes, the area of the layer adjacent to the terminal electrodes 3 and 4 may be maximum, and the area of the layer away from the terminal electrodes 3 and 4 may be smaller. In this case, the 3D-shape of the connecting portions 9 and 10 may be pyramidal or stepped.

What is claimed is:

1. A laminated coil component comprising:
an element body configured with a plurality of laminated insulating layers and having a mounting surface intersecting with respect to a lamination direction;
a coil conductor provided in the element body and having a pair of end portions extending toward the mounting surface along the lamination direction;
a pair of terminal electrodes provided on the mounting surface of the element body, electrically connected to the pair of end portions of the coil conductor, respectively, and facing each other in a first direction on the mounting surface; and
a pair of connecting portions interposed between the pair of the end portions of the coil conductor and the pair of the terminal electrodes, respectively,
wherein the coil conductor includes first wiring portions extending in parallel to the mounting surface, second wiring portions extending in parallel to the mounting surface at a side farther from the mounting surface than the first wiring portions, and pillar portions extending along the lamination direction and connecting the first wiring portion and the second wiring portion,
wherein the first wiring portion includes an inclined portion extending in a direction inclined with respect to the first direction and adjacent to the connecting portion in a second direction orthogonal to the lamination direction and the first direction when viewed from the lamination direction,
wherein the connecting portion has an overlapping portion overlapping the end portion of the coil conductor and an elongated portion extending inwardly from the overlapping portion along the first direction when viewed in the lamination direction, and
wherein a length with respect to the second direction at a proximal end on the overlapping portion side of the elongated portion is longer than that at a distal end, and at least a portion of a contour of the elongated portion on the first wiring portion side is inclined in the same direction as the inclined portion of the first wiring portion when viewed from the lamination direction.

2. The laminated coil component according to claim 1, wherein the whole of the contour of the elongated portion on the first wiring portion side is inclined in the same direction as the inclined portion of the first wiring portion when viewed from the lamination direction.

3. The laminated coil component according to claim 1, wherein the contour of the elongated portion on the first wiring portion side is inclined to be parallel to the inclined portion of the first wiring portion when viewed from the lamination direction.

4. The laminated coil component according to claim 1, wherein the shapes of the pair of the connecting portions have a symmetric relationship.

5. The laminated coil component according to claim 1, wherein the shapes of the pair of the connecting portions have an asymmetric relationship.

6. The laminated coil component according to claim 1, wherein an area of the end portion of the coil conductor is larger than an area of the pillar portion when viewed from the lamination direction.
